(19) United States
(12) Patent Application Publication
(10) Pub. No.: US 2008/0158725 A1
(43) Pub. Date: Jul. 3, 2008

(54) Vibration damping utilizing a patterned visco-elastic polymer

(76) Inventors: Toshiki Hirano, San Jose, CA (US); Haruhide Takahashi, Odawara (JP)

Correspondence Address: HITACHI C/O WAGNER BLECHER LLP, 123 WESTRIDGE DRIVE, WATSONVILLE, CA, 95076, US

(21) Appl. No.: 11/648,047

(22) Filed: Dec. 29, 2006

(51) Int. Cl. G11B 5/012; B05D 3/02; G11B 5/48; G11B 5/54; G03C 5/00

(52) U.S. Cl. 360/86; 360/240; 360/254.6; 427/393.5; 430/313

(57) ABSTRACT

A micro-machined vibration-damping device comprises a patterned visco-elastic polymer and a substrate for receiving the patterned visco-elastic polymer.

### TECHNICAL FIELD

The embodiments of the present invention relate generally to the field of vibration control and in particular to the damping of vibration with a polymer suited for micromachining.

### BACKGROUND ART

Unwanted vibration in a mechanical system can render a mechanical system inoperable if the vibration is severe enough or occurs at a detrimental frequency. Since the beginning of the 20^{th} century mechanical engineers have sought various means for controlling vibrations and keeping mechanisms stable to perform their designed function. Vibration control has evolved into many forms. When designing a vibration control system some of the considerations are size, complexity, operating conditions, and cost.

### SUMMARY OF THE INVENTION

Various embodiments of the present invention are described herein. A micro-machined vibration-damping device comprises a patterned visco-elastic polymer and a substrate for receiving the patterned visco-elastic polymer.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is an isometric blow-apart of an HDD in accordance with one embodiment of the present invention.

FIG. 2 is an isometric detail of a Head gimbal assembly (HGA) in accordance with one embodiment of the present invention.

FIG. 3 is an isometric cut-away detail of an HGA in accordance with one embodiment of the present invention.

FIG. 4 is a plan view of a microactuator in accordance with one embodiment of the present invention.

FIG. 5 is an isometric of an HGA in accordance with one embodiment of the present invention.

FIG. 6 is an isometric blow-apart of an HGA in accordance with one embodiment of the present invention.

FIG. 7 is an isometric blow-apart detail of an HGA in accordance with one embodiment of the present invention.

FIG. 8 is a flow chart illustrating steps of a fabrication process for vibration damping utilizing a patterned visco-elastic polymer in accordance with one embodiment of the present invention.

FIG. 9(a-g) are cross-sections of vibration damping utilizing a patterned visco-elastic polymer at process steps of fabrication in accordance with one embodiment of the present invention.

FIG. 10 is a flow chart illustrating steps of a fabrication process for vibration damping utilizing a patterned visco-elastic polymer and constraining layer in accordance with one embodiment of the present invention.

FIG. 11(a-h) are cross-sections of vibration damping utilizing a patterned visco-elastic polymer and constraining layer at process steps of fabrication in accordance with one embodiment of the present invention.

FIG. 12 is a flow chart illustrating steps of a fabrication process for vibration damping utilizing a patterned visco-elastic polymer in accordance with one embodiment of the present invention.

FIG. 13(a-f) are cross-sections of vibration damping utilizing a patterned visco-elastic polymer at process steps of fabrication in accordance with one embodiment of the present invention.

### DETAILED DESCRIPTION

Reference will now be made in detail to the alternative embodiment(s) of the present invention. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of embodiments of the present invention, numerous specific details are set forth in order to provide a thorough understanding of the present invention. However, it will be recognized by one of ordinary skill in the art that embodiments of the present invention may be practiced without these specific details. In other instances, well known methods, procedures, and components have not been described in detail as not to unnecessarily obscure aspects of the present invention.

The discussion will begin with a brief overview of vibration control techniques and their applications. The discussion will then focus on embodiments of the invention that allow patterning and micro machining of dampers and their application to micro-machined devices. Operation in a hard disk drive (HDD) of embodiments of the present invention will then be discussed. Although the patterning and micro machining of dampers will be described in an HDD, it is understood that the embodiments described herein are useful in a wide variety of industries outside of the HDD industry, in which patterning and micro machining of dampers for vibration control of micro-machined devices is required. An exemplary listing of these industries is avionics, microelectromechanical systems (MEMS) such as digital light processing (DLP) used in digital display technology, and guidance systems in high vibration environments such as missiles, projectiles, and fighter jets.

### Overview

Vibration control can be divided into two main categories, i.e. active damping and passive damping.

Active damping is typically employed on large structures that can tolerate the added mass and complexity of an active damping system. An exemplary active damping system will comprise a means for sensing amplitude and frequency of motion, or vibration, and feed this information to a system that provides a force and motion that acts in an opposite sense to nullify the unwanted motion and vibration.

An example of such an active damping system is that used in tall skyscrapers to counter act induced motion and vibration due to wind loading on a skyscraper's structure. Typically such a system resides on upper floors located where the deformation of the skyscraper is most pronounced. These locations of maximum deformation in a structure are known as node points. In a typical example of skyscraper active damping, as motion is sensed at a node point, the active damping system will engage large actuators, typically hydraulic pistons, to move large masses in directions and frequencies that counter the motion of the skyscraper. In this manner, the swaying motion that would normally occur in a non-damped skyscraper will not affect the occupants of a skyscraper adversely.

Passive damping is more commonly encountered in everyday mechanical devices. A common example of this is the shock absorber built into the suspension system of most land vehicles. A shock absorber is typically placed at each node point, which usually coincide to the attachment points of the vehicle chassis to the wheels. A shock absorber is considered passive because it does not require components to activate its motion to counter act unwanted vibration and motion. It passively reacts to motion it receives.

The energy a passive damper absorbs is dissipated in heat. The exemplary shock absorber absorbs energy by forcing a fluid such as oil or gas through a small orifice as shock absorber is forced to move with the vibration. The fluid resists being forced through the small orifice. The fluid's temperature increases and dissipates the energy imparted into it as heat.

The exemplary shock absorber is suited for absorbing large motion and high amplitude vibration such as that experienced by most land vehicles. Small motion and higher frequency vibration, such as that evidenced by sound is not typically damped well by a shock absorber. Another type of passive vibration is better suited for mitigating high frequency, low amplitude vibration.

There are typically two types of passive damping for high frequency, low amplitude vibration. These are sound coat and viscoelastic damping.

Sound coat is typically applied to large surfaces such as ceilings, walls, and floors of rooms where it is desired to mitigate the reflection and reverberation of sound off these surfaces. It is also used to mitigate large surfaces from vibrating and emanating sound, such as surfaces found in large appliances, automobile hoods and roofs, which can vibrate and produce sound. Sound coat used to mitigate the vibration of surfaces is typically applied at node points of the surface to achieve maximum vibration damping.

Viscoelastic damping relies upon the lossy nature of a material. A lossy material is one that dissipates energy due to its viscous nature and not being readily moved, e.g. tar and molasses. An example of viscoelastic damping can be found in land vehicle bodies. Typically door panels and firewalls in land vehicles will have a patch of asphalt sheet affixed to node points.

The effectiveness of viscoelastic damping can be further enhanced by applying a stiff skin to the outer surface of the viscoelastic material, which has been applied at node points of a surface undergoing vibration mitigation. Mitigating vibration by applying a stiff skin to the outer surface of a viscoelastic material is typically known as constrained layer damping. An example of constrained layer damping can be found in many gas-powered vehicles. Most internal combustion engines made in the past twenty years will have either the valve cover and/or the oil pan and/or the timing gear cover made from two nested shells separated by a thin layer of viscoelastic material. Constrained layer damping of these components reduces their vibration and the unwanted sound that could normally emanate from these components.

A constraining layer coupled to the viscoelastic material transfers shearing motion and strain energy into the viscoelastic material when the constrained layer damper is flexed while coupled to a vibrating surface. The strain energy is dissipated as heat in the viscoelastic material and into the surrounding environment.

Constrained layer damping is the preferred method of vibration control in small precision mechanical devices such as hard disk drives. The viscoelastic material and the stiffness of the constraining layer can be designed to damp out specific frequencies of vibration that would be deleterious to the operation of the mechanical device.

Viscoelastic material typically is available in sheet form with at least one protective release liner to assist in handling. The viscoelastic material and its release liner are cut as one, typically with a punch. Once punched, it is transferred to the surface to be damped, pressed onto the surface, and typically heated to assure the viscoelastic material is adhered to the surface. An example of a viscoelastic material with liner is 3M™ 110P02.

The typical process for obtaining a constrained layer damper is to laminate a constraining layer such as a thin sheet of stainless steel, aluminum, or plastic onto an exposed surface of viscoelastic material such as 3M™ 110P02 while leaving a liner covering the viscoelastic material on the side opposite the laminated constraining layer. The lamination is then passed through a punch and die set to punch out the constrained layer damper. The punch and die set are designed to have the outline of the desired constrained layer damper.

The size and shape of the constrained layer damper is limited to the capabilities of shaping a punch and die set. Typical features of a punch and die set are no less than a few millimeters. The minimum radius on a feature of a punch and die set is approximately 0.13 mm. This limits constrained layer dampers typically to simple shapes such as circles, rectangles, and rhomboids with very few contours.

Embodiments of the present invention provide means and applications for fabricating viscoelastic damping and constrained layer damping in small detailed patterns and shapes that are conducive for use in MEMS devices and mechanical devices requiring micro-machined vibration-damping devices.

### Physical Description

In accordance with an embodiment of the present invention, a micro-machined vibration-damping device comprises a patterned visco-elastic polymer such as 3M™ Form-in-Place Gasket AHS-969 deposited onto a substrate. It has been discovered that a polymer precursor such as 3M™ Form-in-Place Gasket AHS-969, upon being polymerized has vibration damping characteristics that are conducive for use as a vibration-damping device. Prior to polymerization, 3M™ Form-in-Place Gasket AHS-969 can be micro-machined for use on a surface of a micro-machined device.

Polymerization typically involves a curing process where heat is applied or induced in the polymer precursor whereby molecular chains, for example of carbon, hydrogen, oxygen and/or silicon, are cross-linked. The polymer precursor is typically a thermoset elastomer and can act as an adhesive as it is being heated and cured.

To enhance the vibration damping characteristics of the visco-elastic polymer, a constraining layer can be coupled to the surface of the visco-elastic polymer precursor prior to curing. After curing, the visco-elastic polymer is adhered to both the substrate and the constraining layer.

Embodiments of the present invention will now be described in an application of an HDD. The application of embodiments of the present invention in an HDD are exemplary and are not intended to limit these embodiments to the HDD industry nor to the exemplified applications in an HDD. The example of an HDD application is presented for brevity and clarity. One of ordinary skill will appreciate the broader applicability of the embodiments of the present invention within and beyond the HDD industry.

The hard disk drive industry uses micro machining to produce Femto sliders with dimensions in all directions less than a millimeter. The integrated lead suspension (ILS) on which the Femto slider is attached has equally small features. A microactuator, which is fabricated using MEMS technology, has most of its features in the sub-millimeter range. Damping vibration in an HDD and its components has been largely restricted to applying damping devices to components with large features. Damping vibration in micro machined HDD devices in an effective manner requires micro machined damping devices.

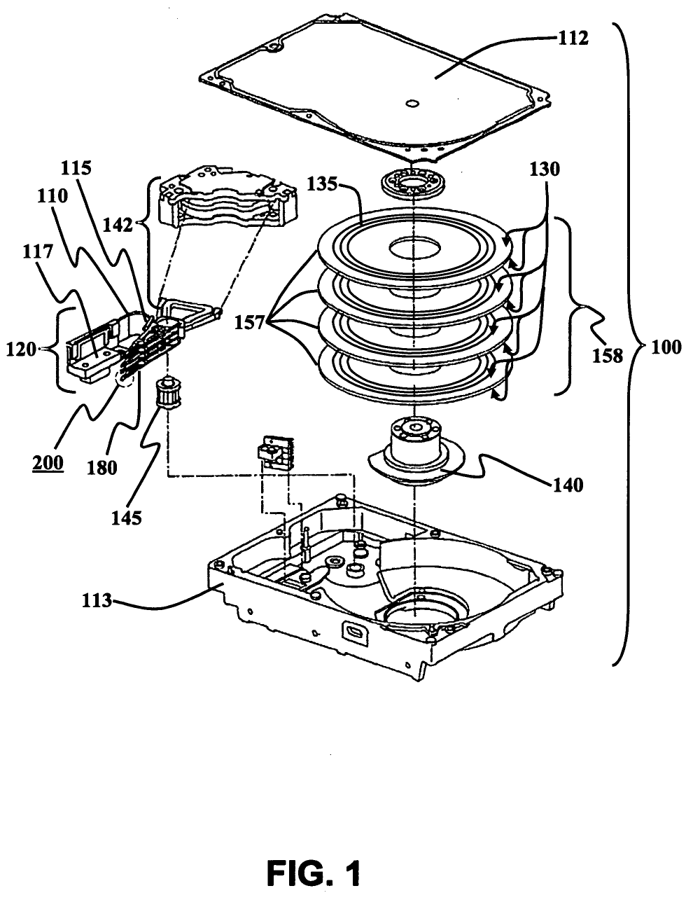

With reference to FIG. 1, an isometric blow-apart of HDD 100 is shown in accordance with an embodiment of this invention. Base casting 113 provides coupling points for components and sub-assemblies such as disk stack 158, voice coil motor (VCM) 142, and actuator assembly 120. Disk stack 158 is coupled to base casting 113 by means of motor-hub assembly 140. Motor hub assembly 140 will have at least one disk 157 coupled to it whereby disk 157 can rotate about an axis common to motor-hub assembly 140 and the center of disk 157. Disk 157 has at least one surface 130 upon which reside data tracks 135. Actuator assembly 120 comprises in part connector 117, which conveys data between arm electronics (A/E) 115 and a host system wherein HDD 100 resides. Flex cable 110, which is part of actuator assembly 120, conveys data between connector 117 and A/E 115.

Actuator assembly 120 is coupled pivotally to base casting 113 by means of pivot bearing 145, whereby VCM 142 can move magnetic transducer 225 arcuately across data tracks 135. Upon assembly of actuator assembly 120, disk stack 158, VCM 142, and other components with base casting 113, cover 112 is coupled to base casting 113 to enclose these components and sub-assemblies into HDD 100.

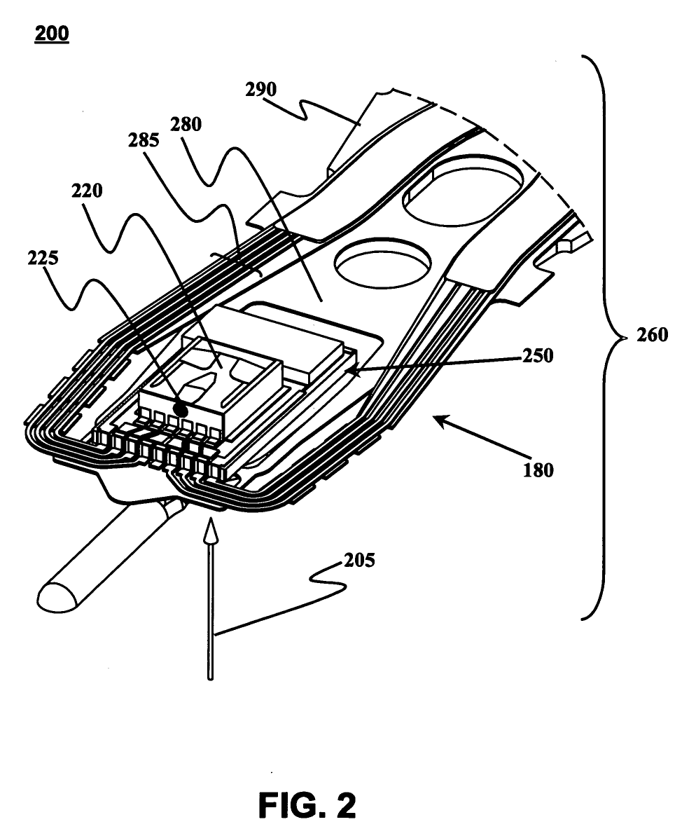

With reference now to FIGS. 1 and 2, and in accordance with an embodiment of the present invention, A/E 115 performs the electronic functions of actuator assembly 120 such as, switching between reading and writing functions of magnetic transducer 225. Upon magnetic transducer 225 reading data tracks 135, A/E 115 amplifies the read data. Upon magnetic transducer 225 writing data tracks 135, A/E 115 provides current to magnetic transducer 225. Also part of actuator assembly 120 is suspension 180. Suspension 180 comprises in part conductors 285, which are coupled to flexure base material 280. Flexure base material 280 is coupled to load beam 290. Generally, suspension 180 is defined as that purchased item upon which high value items, such as slider 220 and microactuator 250 are assembled.

With reference to FIG. 2, an isometric detail 200 of HGA 260 is presented in accordance with an embodiment of the present invention. Detail 200 is the most distal end of the assembly comprising suspension 180, slider 220 and any other components attached to suspension 180, such as microactuator 250. When these components are coupled together, as an assembly they are known as a head gimbal assembly or HGA 260. When microactuator 250 is situated under slider 220 and between suspension 180, it moves slider 220 with respect to suspension 180, in accordance to the position of data tracks 135.

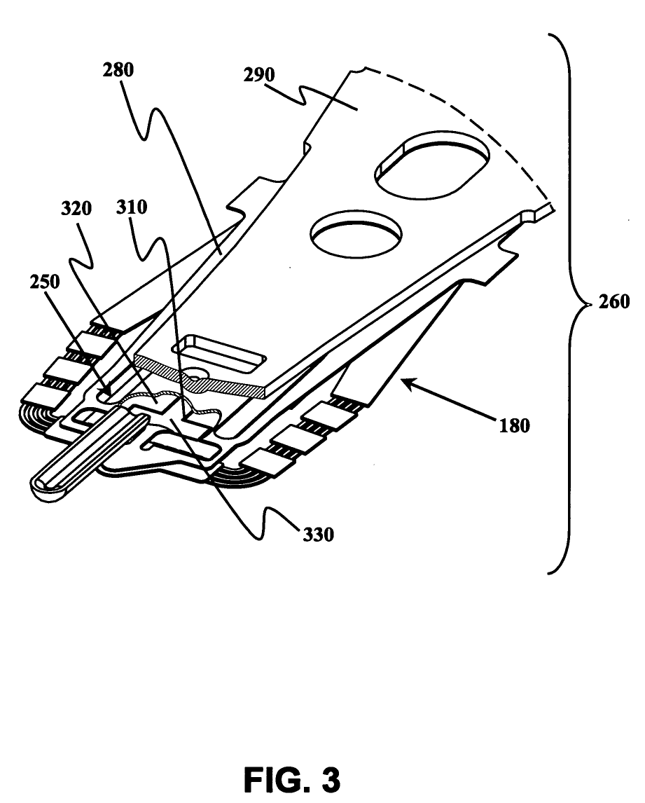

With reference to FIG. 3, and aligned with line of sight 205 in FIG. 2, the opposite side of HGA 260 is visible as to that presented in FIG. 2. Flexure base material 280 and load beam 290 have been partially cut away to expose the backside of microactuator 250. Made visible is channel 310, which is cut into the body of microactuator 250. Channel 310 allows relative motion between mounting feature 320 and mounting feature 330. Mounting feature 330 has a surface, which typically couples to slider 220. Mounting feature 320 has a surface, which typically couples to suspension 180 via flexure base material 280.

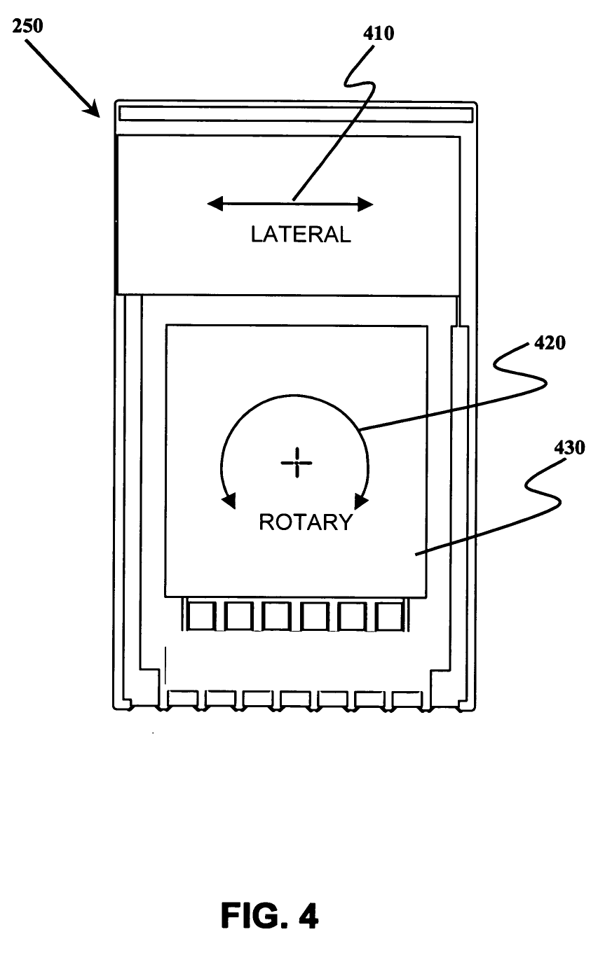

With reference now to FIG. 4 microactuator 250 is presented in plan view in accordance with an embodiment of the present invention. A portion of microactuator 250 can provide lateral actuation 410. Another portion of microactuator 250 can provide rotary actuation 420. Mounting surface 430 provides a surface on which slider 220 can be mounted. Microactuator 250 and mounting surface 430 are located at the distal end of suspension 180.

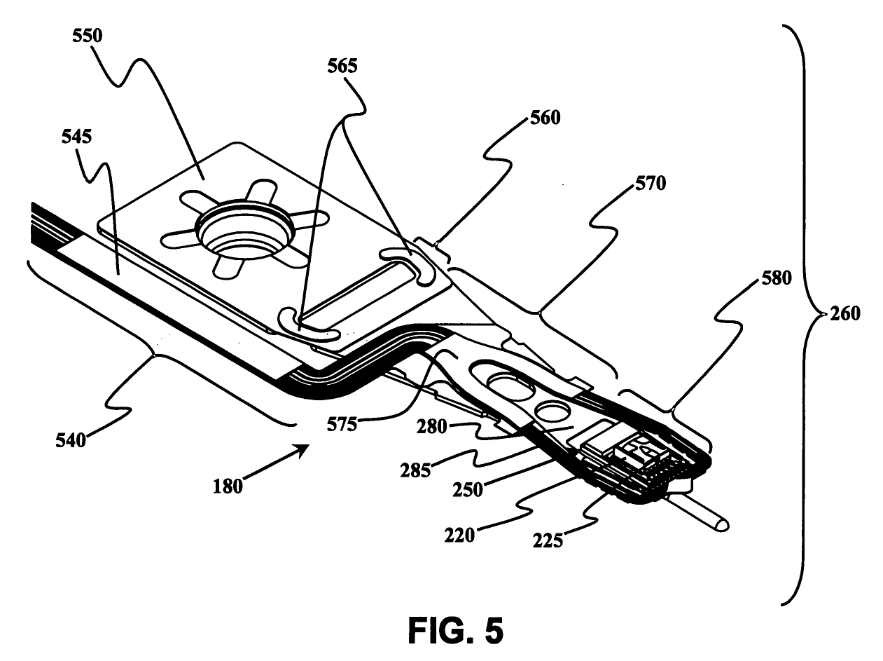

With reference now to FIG. 5 an isometric view of HGA 260 is presented in accordance with an embodiment of the present invention. Its major sections and features that perform functions of HGA 260 can be used to describe HGA 260. It is obvious to one schooled in the art that these sections typically do not have a definitive demarcation and can overlap in location and function.

Tail section 540 is routed generally adjacent to mounting feature 550. Tail section 540 typically couples data signals to and from actuator A/E 115 (FIG. 1) and magnetic transducer 225, as well as other components such as microactuator 250 that may require electrical coupling.

Mounting feature 550 provides coupling of suspension 180 and thusly HGA 260 to an actuator arm. Mounting feature 550 can have a variety of designs, any of which do not limit the scope of the embodiments of this invention.

Spring section 560 of suspension 180 couples mounting feature 550 to rigid section 570. Spring section 560 typically provides a spring force to rigid section 570 such that magnetic transducer 225 is held in close proximity to data tracks 135 (FIG. 1).

Flexible section 580 comprises in part flexure base material 280 and conductors 285. Flexible section 580 provides in part the gimbal action to slider 220 such that slider 220 can follow the contour and perturbations of disk surface 130 (FIG. 1). Flexible section 580 couples rigid section 570 to a mounting surface at the distal end of suspension 180.

With reference now to FIG. 5 and in accordance with an embodiment of the present invention, micro-machined vibration-damping devices (545, 565, 575) are coupled to receiving surfaces on tail section 540, mounting feature 550, spring section 560, and rigid section 570. In accordance with an embodiment of the present invention, a micro-machined vibration-damping device is not limited to coupling one section or feature. For example, micro-machined vibration-damping device 565 couples simultaneously mounting feature 550, spring section 560, and rigid section 570. The micro-machined vibration-damping devices presented in FIG. 5 are examples of configurations of micro-machined vibration-damping devices. Their pattern and location at node points vary with the configuration of suspension 180 and are designed to attenuate oscillations of suspension 180. Their shape and location are in no way intended to limit the scope of the embodiments of the present invention.

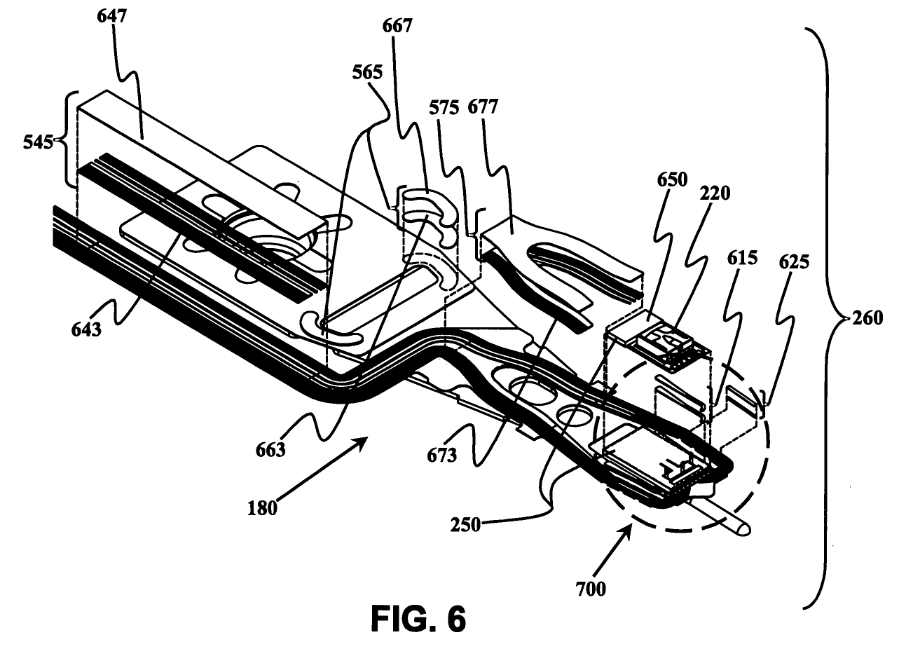

With reference now to FIG. 6 an isometric blow-apart of HGA 260 is presented in accordance with an embodiment of the present invention. Micro-machined vibration-damping devices (615, 625) are coupled to receiving surfaces on flexible section 580. The actuation device 650 of microactuator 250 and slider 220 are exploded to present further details of HGA 260 and embodiments of the present invention.

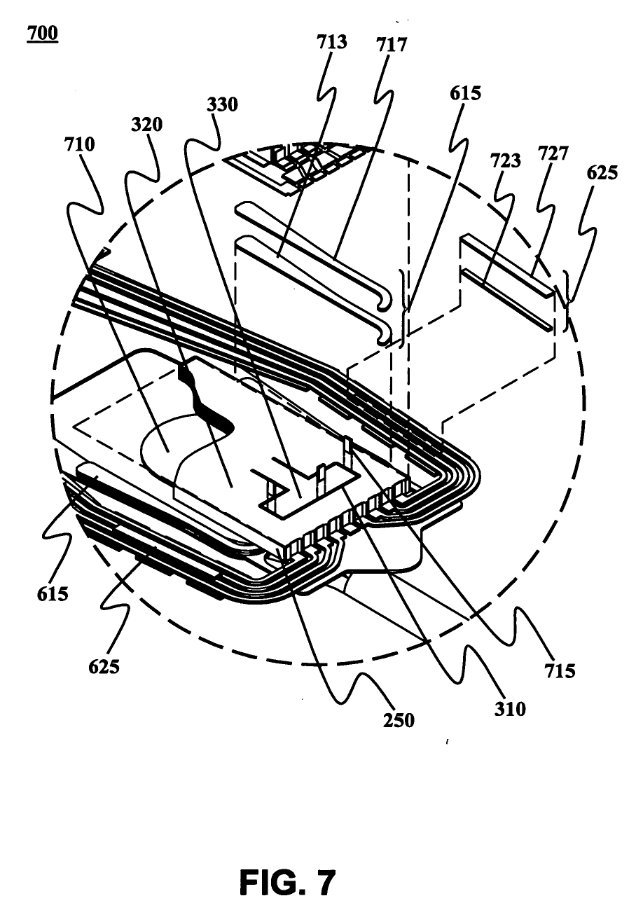

With reference now to FIG. 7 an isometric blow-apart detail 700 of HGA 260 is presented in accordance with one embodiment of the present invention. Micro-machined vibration-damping devices (615, 625) are presented as exploded and in situ. Microactuator 250 is cut away to reveal mounting surface 710. Mounting surface 710 is comprised of flexure base material 280. In accordance with an embodiment of the present invention, in the absence of microactuator 250, slider 220 couples to mounting surface 710.

A typical distal mounting surface is a surface that is in close proximity to slider 220. A typical distal mounting surface may also couple to another adjacent surface such as mounting surface 710, a surface on mounting feature 320, and a surface on mounting feature 330.

In accordance with an embodiment of the present invention, a distal mounting surface is also a surface that comprises channel 310. Channel 310 comprises a cavity that is open on at least one side. Micro-machined vibration-damping device 715 is presented exploded out of channel 310 in FIG. 7. Micro-machined vibration-damping device 715 is coupled to mounting feature 320 and to mounting feature 330. Coupling occurs upon introduction of a liquid visco-elastic polymer precursor such as 3M™ Form-in-Place Gasket AHS-969 and curing the liquid visco-elastic polymer precursor in channel 310. In so doing, oscillations that may occur relative to mounting feature 320 and mounting feature 330 are attenuated and damped by micro-machined vibration-damping device 715.

With reference to FIG. 6 and to FIG. 7 and in accordance with an embodiment of the present invention, micro-machined vibration-damping device (545, 565, 575, 615, 625) comprise constraining layer (647, 667, 677, 717, 727) and patterned and polymerized visco-elastic polymer precursor (643, 663, 673, 713, 723). In accordance with another embodiment of the present invention, micro-machined vibration-damping device (545, 565, 575, 615, 625) comprise patterned and polymerized visco-elastic polymer precursor (643, 663, 673, 713, 723) without constraining layer (647, 667, 677, 717, 727).

### Operation

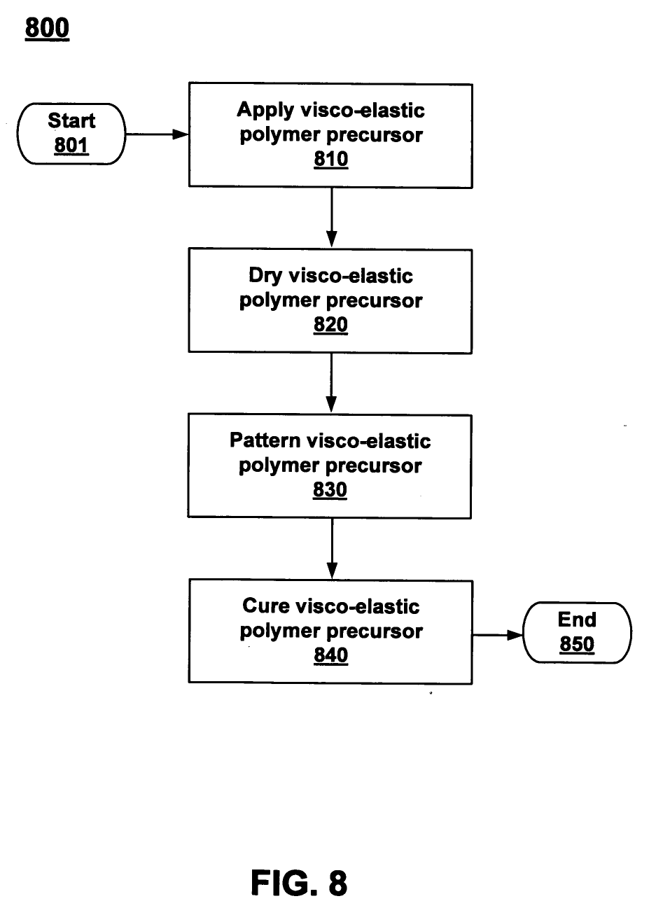

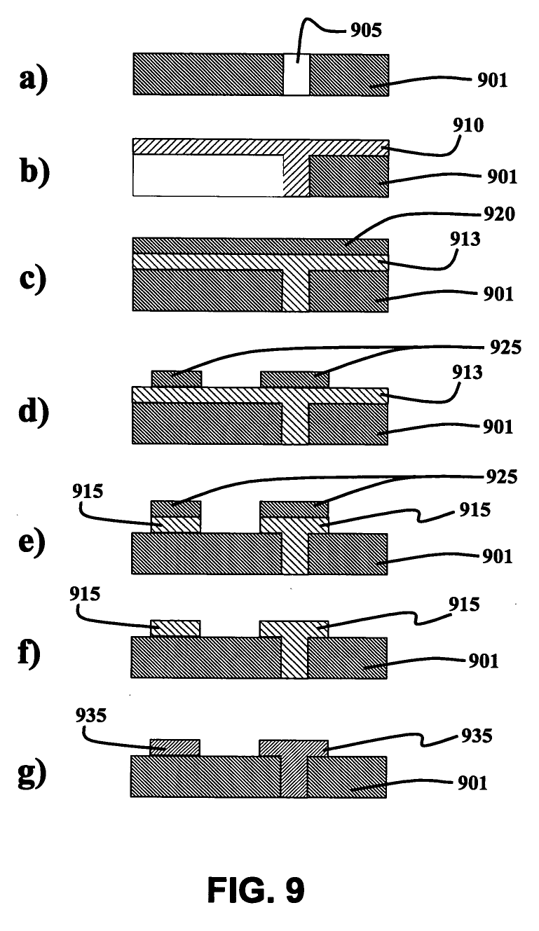

FIG. 8 is a flow chart of a process 800 in which particular steps are performed in accordance with an embodiment of the present invention for micromachining a vibration damping device. FIG. 9 presents cross-sections of an exemplary vibration damping device at sequential process steps of fabrication presented in process 800 of FIG. 8. Although process 800 presents steps for micromachining a vibration damping device, in other embodiments process 800 may also be used to fabricate a vibration damping device that is not considered to be of micro size. Although specific steps are disclosed in process 800, such steps are exemplary. That is, the embodiments of the present invention is well suited to performing various other steps or variations of the steps recited in FIG. 8. Within the present embodiment, it should be appreciated that the steps of process 800 may be performed by software, by hardware, by an assembly mechanism, through human interaction, or by any combination of software, hardware, assembly mechanism, and human interaction.

Process 800 will be described with reference to elements shown in FIGS. 9a-9g.

In step 801 of process 800, a suitable substrate 901 (FIG. 9a) is introduced into process 800 in an embodiment of the present invention. A suitable substrate for micromachining a vibration damping device such as process 800 is a substrate that has a relatively flat surface. In some embodiments there may be features and topography such as exemplary cavity 905 that the vibration damping device once completed will incorporate.

In step 810 of process 800, liquid visco-elastic polymer precursor 910 (FIG. 9b) such as 3M™ Form-in-Place Gasket AHS-969 is applied to substrate 901 in an embodiment of the present invention. A variety of methods for applying a liquid such as liquid visco-elastic polymer precursor 910 are known in the industry. Examples of these methods are dipping, spin coating, spraying, and doctor blading. These examples are not intended to be an all-inclusive listing of application methods but are only presented to be exemplary of the variety of liquid applications available for liquid visco-elastic polymer precursor 910.

In step 820 of process 800, liquid visco-elastic polymer precursor 910 is dried after application to substrate 901 in an embodiment of the present invention. Drying is time and temperature dependent, i.e. a longer drying time requires a lower temperature. In one embodiment a typical drying time and temperature for liquid visco-elastic polymer precursor 910 (FIG. 9b) such as 3M™ Form-in-Place Gasket AHS-969 is 1 hour at 100° C. Drying is required so that visco-elastic polymer precursor becomes sufficiently stable for further processing.

In step 830 of process 800, dried visco-elastic polymer precursor 913 is patterned in an embodiment of the present invention. In accordance with an embodiment of the present invention the patterning process comprises photolithography and etching (FIGS. 9c-9f).

With reference to FIG. 9c, photoresist 920 is applied to dried visco-elastic polymer precursor 913 and irradiated with ultraviolet light through a photo tool. In an embodiment of the present invention, photoresist 920 can be either a liquid photoresist or a dry photoresist. Photolithography imaging techniques with liquid and dry photoresist are well known in the industry.

With reference to FIG. 9d, photoresist 920 is developed to become patterned photoresist 925. Patterned photoresist 925 comprises the desired pattern for a visco-elastic damping device.

With reference to FIG. 9e, and in an embodiment of the present invention patterned photoresist 925 imparts its pattern to dried visco-elastic polymer precursor 913 (FIG. 9d) resulting in patterned dried visco-elastic polymer precursor 915. Patterning of dried visco-elastic polymer precursor 913 is accomplished through the application of an organic solvent such as N-Methylpyrrolidone (NMP) to dried visco-elastic polymer precursor 913. The organic solvent reacts with dried visco-elastic polymer precursor 913 that is exposed by patterned photoresist 925. The reaction of the organic solvent facilitates the removal of reacted dried visco-elastic polymer precursor 913 resulting in patterned dried visco-elastic polymer precursor 915. Alternatively, a dry-etching technique, such as oxygen plasma can be used to selectively remove dried visco-elastic polymer precursor 913.

With reference to FIG. 9f, patterned photoresist 925 is removed from patterned dried visco-elastic polymer precursor 915.

With reference to FIG. 9f, and in an embodiment of the present invention, by applying liquid visco-elastic polymer precursor 910 at process step 9b by a technique known in the industry as screen printing, preceding sequential process steps 9c, 9d, and 9e are eliminated. Screen printing applies liquid visco-elastic polymer precursor 910 through a screen or stencil, which comprises the desired pattern for patterned dried visco-elastic polymer precursor 915. After screen printing liquid visco-elastic polymer precursor 910 through a screen or stencil, liquid visco-elastic polymer precursor 910 is dried, resulting in patterned dried visco-elastic polymer precursor 915.

With reference to FIG. 9f, and in an embodiment of the present invention, liquid visco-elastic polymer precursor 910 is applied in a pattern with a syringe, thus eliminating preceding sequential process steps 9c, 9d, and 9e. Syringe application typically comprises squirting liquid visco-elastic polymer precursor 910 onto substrate 901 in the pattern of a vibration damping device. Syringe application is a general term known in the industry for squirting a liquid through a small orifice. A syringe is not required for squirting liquid visco-elastic polymer precursor 910 onto substrate 901. After squirting liquid visco-elastic polymer precursor 910 onto substrate 901, liquid visco-elastic polymer precursor 910 is dried, resulting in patterned dried visco-elastic polymer precursor 915.

In step 840 of process 800, patterned dried visco-elastic polymer precursor 915 is cured (FIG. 9g) resulting in a micro-machined visco-elastic damping device 935 adhered to substrate 901 in an embodiment of the present invention. Curing is time and temperature dependent, i.e. a longer curing time requires a lower temperature. In one embodiment a typical curing time and temperature for liquid visco-elastic polymer precursor 910 (FIG. 9b) such as 3M™ Form-in-Place Gasket AHS-969 is 2 hours at 120° C. After the application of an appropriate curing time and temperature patterned dried visco-elastic polymer precursor 915 (FIG. 9f) is polymerized.

In step 850 of process 800, substrate 901 is now capable of mitigating and attenuating vibrations and oscillations of a micro-machined device in an embodiment of the present invention.

Process 800, though presented as a method for fabricating a micro-machined vibration damping device, is not limited to a micro-machined device. A vibration damping device that can be made with existing art may also use the methods presented in process 800.

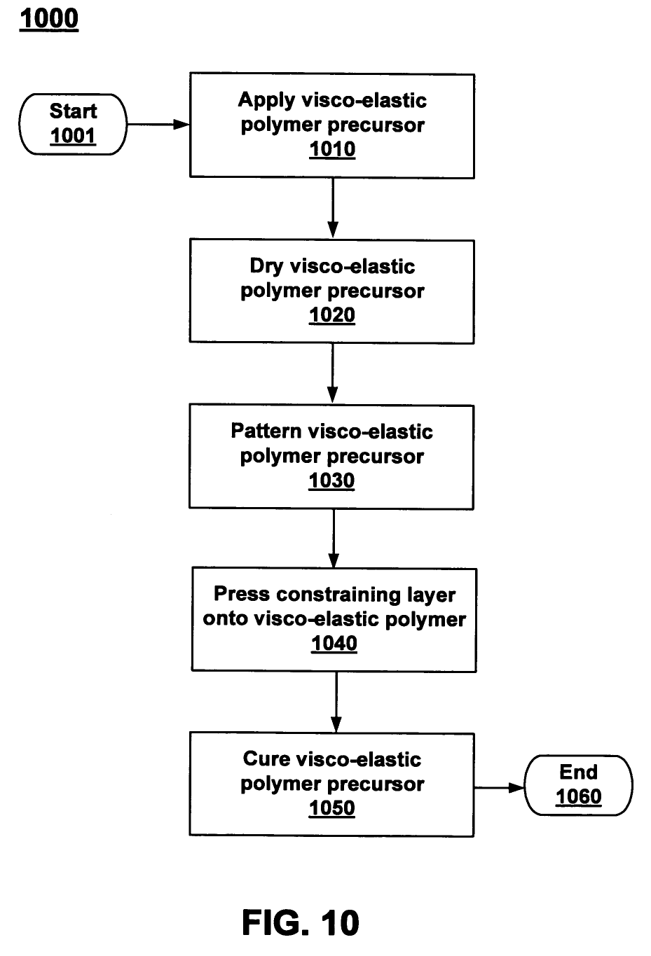

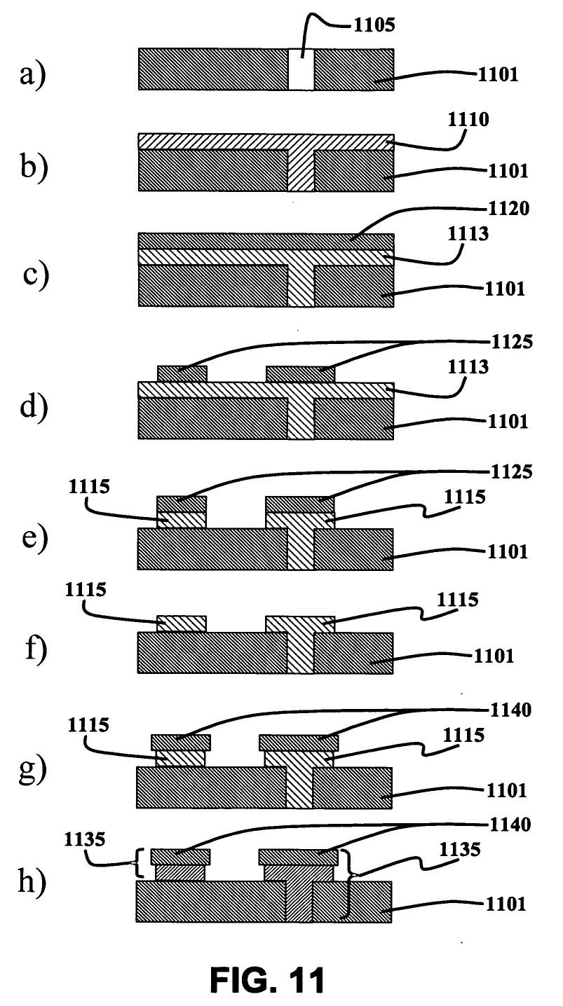

FIG. 10 is a flow chart of a process 1000 in which particular steps are performed in accordance with an embodiment of the present invention for micromachining a vibration damping device. FIG. 11 presents cross-sections of an exemplary vibration damping device at sequential process steps of fabrication presented in process 1000 of FIG. 10. Although process 1000 presents steps for micromachining a vibration damping device, process 1000 may also be used to fabricate a vibration damping device that is not considered to be of micro size. Although specific steps are disclosed in process 1000, such steps are exemplary. That is, the embodiments of the present invention are well suited to performing various other steps or variations of the steps recited in FIG. 10. Within the present embodiment, it should be appreciated that the steps of process 1000 may be performed by software, by hardware, by an assembly mechanism, through human interaction, or by any combination of software, hardware, assembly mechanism, and human interaction.

Process 1000 will be described with reference to elements shown in FIGS. 11a-11h.

In step 1001 of process 1000, a suitable substrate 1101 (FIG. 11a) is introduced into process 1000 in an embodiment of the present invention. A suitable substrate for micromachining a vibration damping device such as process 1000 is a substrate that has a relatively flat surface. In some embodiments there may be features and topography such as exemplary cavity 1105 that the vibration damping device once completed will incorporate.

In step 1010 of process 1000, liquid visco-elastic polymer precursor 1110 (FIG. 11b) such as 3M™ Form-in-Place Gasket AHS-969 is applied to substrate 1101 in an embodiment of the present invention. A variety of methods for applying a liquid such as liquid visco-elastic polymer precursor 1110 are known in the industry. Examples of these methods are dipping, spin coating, spraying, and doctor blading. These examples are not intended to be an all-inclusive listing of application methods but are only presented to be exemplary of the variety of liquid applications available for liquid visco-elastic polymer precursor 1110.

In step 1020 of process 1000, liquid visco-elastic polymer precursor 1110 is dried after application to substrate 1101 in an embodiment of the present invention. Drying is time and temperature dependent, i.e. a longer drying time requires a lower temperature. In one embodiment a typical drying time and temperature for liquid visco-elastic polymer precursor 1110 (FIG. 11b) such as 3M™ Form-in-Place Gasket AHS-969 is 1 hour at 100° C. Drying is required so that visco-elastic polymer precursor becomes sufficiently stable for further processing.

In step 1030 of process 1000, dried visco-elastic polymer precursor 1113 is patterned in an embodiment of the present invention. In accordance with an embodiment of the present invention the patterning process comprises photolithography and etching (FIGS. 11c-11f).

With reference to FIG. 11c, photoresist 1120 is applied to dried visco-elastic polymer precursor 1113 and irradiated with ultraviolet light through a photo tool. In an embodiment of the present invention, photoresist 1120 can be either a liquid photoresist or a dry photoresist. Photolithography imaging techniques with liquid and dry photoresist are well known in the industry.

With reference to FIG. 11d, photoresist 1120 is developed to become patterned photoresist 1125. Patterned photoresist 1125 comprises the desired pattern for a constrained layer damping device.

With reference to FIG. 11e, and in an embodiment of the present invention patterned photoresist 1125 imparts its pattern to dried visco-elastic polymer precursor 1113 (FIG. 11d) resulting in patterned dried visco-elastic polymer precursor 1115. Patterning of dried visco-elastic polymer precursor 1113 is accomplished through the application of an organic solvent such as N-Methylpyrrolidone (NMP) to dried visco-elastic polymer precursor 1113. The organic solvent reacts with dried visco-elastic polymer precursor 1113 that is exposed by patterned photoresist 1125. The reaction of the organic solvent facilitates the removal of reacted dried visco-elastic polymer precursor 1113 resulting in patterned dried visco-elastic polymer precursor 1115. Alternatively, a dry-etching technique, such as oxygen plasma can be used to selectively remove dried visco-elastic polymer 1115.

With reference to FIG. 11f, patterned photoresist 1125 is removed from patterned dried visco-elastic polymer precursor 1115.

With reference to FIG. 11 f, and in an embodiment of the present invention, by applying liquid visco-elastic polymer precursor 1110 at process step 11b by a technique known in the industry as screen printing, preceding sequential process steps 11c, 11d, and 11e can be eliminated. Screen printing applies liquid visco-elastic polymer precursor 1110 through a screen or stencil, which comprises the desired pattern for patterned dried visco-elastic polymer precursor 1115. After screen printing liquid visco-elastic polymer precursor 1110 through a screen or stencil, liquid visco-elastic polymer precursor 1110 is dried, resulting in patterned dried visco-elastic polymer precursor 1115.

With reference to FIG. 11f, and in an embodiment of the present invention, liquid visco-elastic polymer precursor 1110 is applied in a pattern with a syringe, thus eliminating preceding sequential process steps 11c, 11d, and 11e. Syringe application typically comprises squirting liquid visco-elastic polymer precursor 1110 onto substrate 1101 in the pattern of a vibration damping device. Syringe application is a general term known in the industry for squirting a liquid through a small orifice. A syringe is not required for squirting liquid visco-elastic polymer precursor 1110 onto substrate 1101. After squirting liquid visco-elastic polymer precursor 1110 onto substrate 1101, liquid visco-elastic polymer precursor 1110 is dried, resulting in patterned dried visco-elastic polymer precursor 1115.

In step 1040 of process 1000, constraining layer 1140 is pressed onto patterned dried visco-elastic polymer precursor 1115 (FIG. 11g) in an embodiment of the present invention. In an embodiment of the present invention pressing of constraining layer 1140 comprises a parallel platen contacting constraining layer 1140 and an opposing parallel platen contacting substrate 1101, whereby heat and pressure can be applied to constraining layer 1140.

In step 1050 of process 1000, patterned dried visco-elastic polymer precursor 1115 is cured (FIG. 11g) resulting in a micro-machined constrained layer damping device 1135 (FIG. 11h) adhered to substrate 1101 and to constraining layer 1140 in an embodiment of the present invention. In one embodiment a typical curing time and temperature for liquid visco-elastic polymer precursor 1110 (FIG. 11b) such as 3M™ Form-in-Place Gasket AHS-969 is 2 hours at 120° C. After the application of an appropriate curing time and temperature patterned dried visco-elastic polymer precursor 1115 (FIG. 11g) is polymerized.

In step 1060 of process 1000, substrate 1101 is now capable of mitigating and attenuating vibrations and oscillations of a micro-machined device of which it comprises in an embodiment of the present invention.

Process 1000, though presented as a method for fabricating a micro-machined vibration damping device, is not limited to a micro-machined device. A vibration damping device that can be made with existing art may also use the methods presented in process 1000.

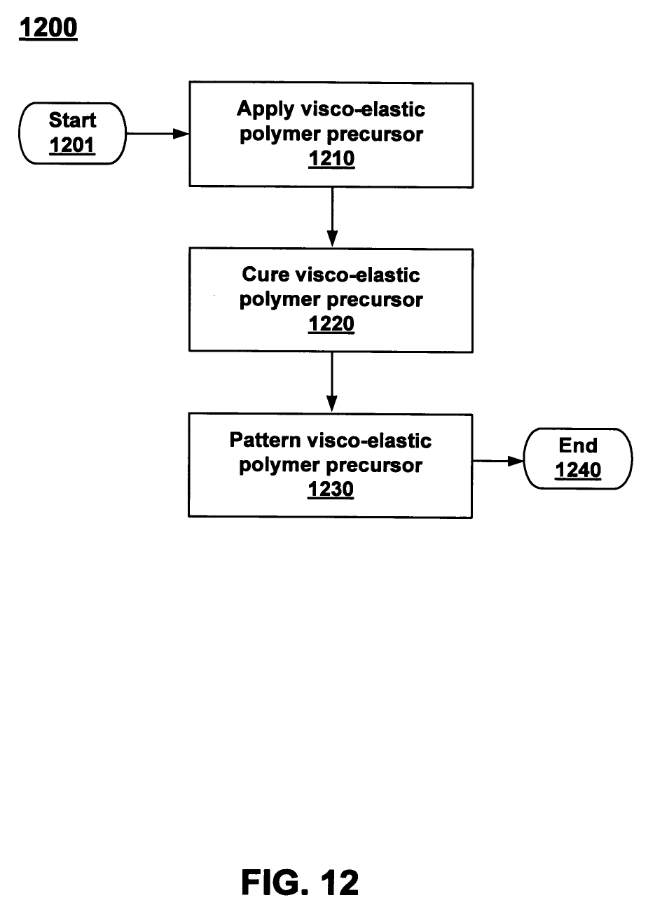

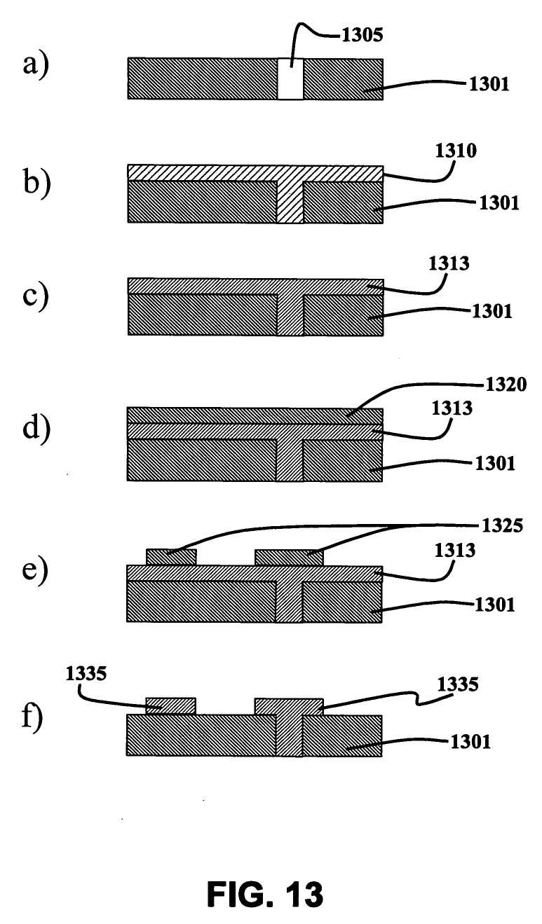

FIG. 12 is a flow chart of a process 1200 in which particular steps are performed in accordance with an embodiment of the present invention for micromachining a vibration damping device. FIG. 13 presents cross-sections of an exemplary vibration damping device at sequential process steps of fabrication presented in process 1200 of FIG. 12. Although process 1200 presents steps for micromachining a vibration damping device, process 1200 may also be used to fabricate a vibration damping device that is not considered to be of micro size. Although specific steps are disclosed in process 1200, such steps are exemplary. That is, the embodiments of the present invention is well suited to performing various other steps or variations of the steps recited in FIG. 12. Within the present embodiment, it should be appreciated that the steps of process 1200 may be performed by software, by hardware, by an assembly mechanism, through human interaction, or by any combination of software, hardware, assembly mechanism, and human interaction.

Process 1200 will be described with reference to elements shown in FIGS. 13a-13f.

In step 1201 of process 1200, a suitable substrate 1301 (FIG. 13a) is introduced into process 1200 in an embodiment of the present invention. A suitable substrate for micromachining a vibration damping device such as process 1200 is a substrate that has a relatively flat surface. In some embodiments of the present invention there may be features and topography such as exemplary cavity 1305 that the vibration damping device once completed will incorporate.

In step 1210 of process 1200, liquid visco-elastic polymer precursor 1310 (FIG. 13b) such as 3M™ Form-in-Place Gasket AHS-969 is applied to substrate 1301 in an embodiment of the present invention. A variety of methods for applying a liquid such as liquid visco-elastic polymer precursor 1310 are known in the industry. Examples of these methods are dipping, spin coating, spraying, and doctor blading. These examples are not intended to be an all-inclusive listing of application methods but are only presented to be exemplary of the variety of liquid applications available for liquid visco-elastic polymer precursor 1310.

In step 1220 of process 1200, liquid visco-elastic polymer precursor 1310 is cured and becomes polymerized visco-elastic polymer 1313 (FIG. 13c) application to substrate 1301 in an embodiment of the present invention. Curing is time and temperature dependent, i.e. a longer curing time requires a lower temperature. In one embodiment of the present invention a typical curing time and temperature for liquid visco-elastic polymer precursor 1310 (FIG. 13b) such as 3M™ Form-in-Place Gasket AHS-969 is 2 hours at 120° C. After the application of an appropriate curing time and temperature liquid visco-elastic polymer precursor 1310 (FIG. 13b) is polymerized (FIG. 13c).

In step 1230 of process 1200, polymerized visco-elastic polymer precursor 1313 (FIG. 13c) is patterned in an embodiment of the present invention. In accordance with an embodiment of the present invention the patterning process comprises photolithography and etching (FIGS. 13d-13f).

With reference to FIG. 13d, photoresist 1320 is applied to polymerized visco-elastic polymer precursor 1313 and irradiated with ultraviolet light through a photo tool. In an embodiment of the present invention, photoresist 1320 can be either a liquid photoresist or a dry photoresist. Photolithography imaging techniques with liquid and dry photoresist are well known in the industry.

With reference to FIG. 13e, photoresist 1320 is developed to become patterned photoresist 1325. Patterned photoresist 1325 comprises the desired pattern for a visco-elastic damping device.

With reference to FIGS. 13e and 13f, and in an embodiment of the present invention patterned photoresist 1325 imparts its pattern to polymerized visco-elastic polymer precursor 1313 resulting in patterned polymerized visco-elastic polymer precursor 1335. Patterning of polymerized visco-elastic polymer precursor 1335 is accomplished through the application of oxygen plasma to polymerized visco-elastic polymer precursor 1313. The oxygen plasma removes polymerized visco-elastic polymer precursor 1313 that is exposed by patterned photoresist 1325 resulting in patterned polymerized visco-elastic polymer precursor 1315. Patterned photoresist 1325 is removed from patterned polymerized visco-elastic polymer precursor 1335.

With reference to FIG. 13f, and in an embodiment of the present invention, by applying liquid visco-elastic polymer precursor 1310 at process step 13b by a technique known in the industry as screen printing, preceding sequential process steps 13d, and 13e can be eliminated. Screen printing applies liquid visco-elastic polymer precursor 1310 through a screen or stencil, which comprises the desired pattern for patterned polymerized visco-elastic polymer precursor 1335. After screen printing liquid visco-elastic polymer precursor 1310 through a screen or stencil, liquid visco-elastic polymer precursor 1310 is cured, resulting in patterned polymerized visco-elastic polymer precursor 1335.

With reference to FIG. 13f, and in an embodiment of the present invention, liquid visco-elastic polymer precursor 1310 is applied in a pattern with a syringe, thus eliminating preceding sequential process steps 13d and 13e. Syringe application typically comprises squirting liquid visco-elastic polymer precursor 1310 onto substrate 1301 in the pattern of a vibration damping device. Syringe application is a general term known in the industry for squirting a liquid through a small orifice. A syringe is not required for squirting liquid visco-elastic polymer precursor 1310 onto substrate 1301. After squirting liquid visco-elastic polymer precursor 1310 onto substrate 1301, liquid visco-elastic polymer precursor 1310 is cured, resulting in patterned polymerized visco-elastic polymer precursor 1335.

In step 1240 of process 1200, a micro-machined visco-elastic damping device 1335 is adhered to substrate 1301 in an embodiment of the present invention. Substrate 1301 is now capable of mitigating and attenuating vibrations and oscillations of a micro-machined device of which it comprises in an embodiment of the present invention.

Process 1200, though presented as a method for fabricating a micro-machined vibration damping device, is not limited to a micro-machined device. A vibration damping device that can be made with existing art may also use the methods presented in process 1200.

The present invention, in the various presented embodiments allows for the fabrication of a vibration damping device that is very small in size and proportion and provides mitigation and attenuation of unwanted oscillations and vibrations in small devices. The embodiments of the present invention although presented as applications in the HDD industry have application outside of the HDD industry. Applications of the embodiments of the present invention although presented for fabricating small vibration damping devices are not limited from being applied to larger vibration damping devices.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A micro-machined vibration-damping device comprising:
a patterned visco-elastic polymer; and
a substrate for receiving said patterned visco-elastic polymer.

2. The micro-machined vibration-damping device of claim 1 wherein said substrate comprises a surface of a micro-machined device.

3. The micro-machined vibration-damping device of claim 1 further comprising a constraining layer.

4. A microactuator for use in a hard disk drive comprising:
a first mounting surface for attaching a suspension;
a second mounting surface for attaching a slider wherein said slider comprises a magnetic transducer for reading and writing data tracks onto a surface of a disk;
an actuation device for moving said first mounting surface relative to said second mounting surface; and
a micro-machined vibration-damping device coupled between said first mounting surface and said second mounting surface, wherein said micro-machined vibration damping device is configured to attenuate oscillations of said second mounting surface with respect to said first mounting surface.

5. The microactuator of claim 4 wherein said micro-machined vibration-damping device comprises a patterned visco-elastic polymer.

6. The microactuator of claim 4 wherein said micro-machined vibration-damping device further comprises a constraining layer.

7. A suspension for use in a hard disk drive comprising:
a tail section for coupling data signals to and from actuator arm electronics;
a mounting feature for coupling an actuator arm;
a spring section coupling said mounting feature to a rigid section;
a flexible section coupling said rigid section to a distal mounting surface; and
a receiving surface for receiving a micro-machined vibration-damping device.

8. The suspension of claim 7 wherein said receiving surface for receiving a micro-machined vibration-damping device is selected from the group of surfaces consisting of:
a surface on said tail section, a surface on said mounting feature, a surface on said spring section, a surface on said flexible surface, and a surface on said distal mounting surface.

9. The suspension of claim 7 wherein said micro-machined vibration-damping device comprises a patterned and polymerized visco-elastic polymer.

10. The suspension of claim 7 wherein said micro-machined vibration-damping device further comprises a constraining layer.

11. A hard disk drive comprising:
a base casting for providing coupling points for components and sub-assemblies of said hard disk drive;
a motor-hub assembly to which at least one disk is coupled allowing rotation of said disk about an axis approximately perpendicular and centered to said disk, wherein said motor-hub assembly is coupled to said base casting, wherein said disk comprising at least one surface of data tracks;
a magnetic transducer for reading and writing said data tracks onto said surface;
a slider comprising said magnetic transducer;
a suspension coupled to said slider, wherein said suspension is coupled to an actuator assembly for moving said slider arcuately across said data tracks;
a microactuator coupled between said suspension and said slider enabling said slider to follow deviations in said data track location; and a micro-machined vibration damping device coupled to said microactuator, wherein said micro-machined vibration damping device comprises a patterned and cured visco-elastic polymer precursor configured for attenuating oscillations of said microactuator.

12. The hard disk drive of claim 11 wherein said micro-machined vibration-damping device further comprises a constraining layer.

13. The hard disk drive of claim 11 wherein said microactuator comprises a cavity open on at least one side for receiving a liquid visco-elastic polymer precursor.

14. A hard disk drive comprising:
a base casting for providing coupling points for components and sub-assemblies of said hard disk drive;
a motor-hub assembly to which at least one disk is coupled allowing rotation of said disk about an axis approximately perpendicular and centered to said disk, wherein said motor-hub assembly is coupled to said base casting, wherein said disk comprising at least one surface of data tracks;
a magnetic transducer for reading and writing said data tracks onto said surface;
a slider comprising said magnetic transducer;
a suspension coupled to said slider, wherein said suspension is coupled to an actuator assembly for moving said slider arcuately across said data tracks; and
a micro-machined vibration damping device coupled to said suspension, wherein said micro-machined vibration damping device comprises a patterned and polymerized visco-elastic polymer precursor configured for attenuating oscillations of said suspension.

15. The hard disk drive of claim 14 wherein said micro-machined vibration-damping device further comprises a constraining layer.

16. The hard disk drive of claim 14 wherein said microactuator comprises a cavity open on at least one side for receiving a liquid visco-elastic polymer precursor.

17. A method of micromachining a vibration damping device, said method comprising:
applying a liquid visco-elastic polymer precursor to a substrate;
drying said liquid visco-elastic polymer precursor whereby said liquid visco-elastic polymer precursor becomes a dried visco-elastic polymer precursor;
patterning said dried visco-elastic polymer precursor whereby said dried visco-elastic polymer precursor becomes a patterned visco-elastic polymer precursor; and
curing said patterned visco-elastic polymer precursor such that said visco-elastic polymer precursor is polymerized resulting in a micro-machined visco-elastic damping device.

18. The method of claim 17 wherein said applying said liquid visco-elastic polymer precursor comprises:
screen printing said liquid visco-elastic polymer precursor.

19. The method of claim 17 wherein said applying said liquid visco-elastic polymer precursor comprises:
applying said liquid visco-elastic polymer to a cavity defined in said substrate, said cavity open on at least one side for receiving said liquid visco-elastic polymer.

20. The method of claim 17 wherein said patterning said dried visco-elastic polymer precursor comprises:
utilizing photolithography to pattern said dried visco-elastic polymer precursor.

21. The method of claim 20 wherein said utilizing photolithography to pattern said dried visco-elastic polymer precursor comprises:
utilizing liquid photoresist to pattern said dried visco-elastic polymer precursor.

22. The method of claim 20 wherein said utilizing photolithography to pattern said dried visco-elastic polymer precursor comprises:
utilizing dry photoresist to pattern said dried visco-elastic polymer precursor.

23. The method of claim 17 wherein said patterning said dried visco-elastic polymer precursor comprises:
applying an organic solvent to said dried visco-elastic polymer precursor.

24. The method of claim 17 further comprising:
pressing a constraining layer onto said dried visco-elastic polymer precursor.

25. A method of micromachining a vibration damping device, said method comprising:
applying a liquid visco-elastic polymer precursor to a substrate;
curing said liquid visco-elastic polymer precursor whereby said liquid visco-elastic polymer precursor is polymerized; and
patterning said polymerized visco-elastic polymer precursor resulting in a micro-machined visco-elastic damping device.

26. The method of claim 25 wherein said applying said liquid visco-elastic polymer precursor comprises:
screen printing said liquid visco-elastic polymer precursor.

27. The method of claim 25 wherein said applying said liquid visco-elastic polymer precursor comprises:
applying said liquid visco-elastic polymer to a cavity defined in said substrate, said cavity open on at least one side for receiving said liquid visco-elastic polymer.

28. The method of claim 25 wherein said patterning said polymerized visco-elastic polymer precursor comprises:
utilizing photolithography to pattern said dried visco-elastic polymer precursor.

29. The method of claim 28 wherein said utilizing photolithography to pattern said polymerized visco-elastic polymer precursor comprises:
utilizing liquid photoresist to pattern said dried visco-elastic polymer precursor.

30. The method of claim 28 wherein said utilizing photolithography to pattern said polymerized visco-elastic polymer precursor comprises:
utilizing dry photoresist to pattern said dried visco-elastic polymer precursor.

31. The method of claim 25 wherein said patterning said polymerized visco-elastic polymer precursor comprises:
applying oxygen plasma to said polymerized visco-elastic polymer precursor.

32. A method for damping vibration, said method comprising:
applying a liquid visco-elastic polymer precursor to a substrate;
drying said liquid visco-elastic polymer precursor whereby said liquid visco-elastic polymer precursor becomes a dried visco-elastic polymer precursor;
patterning said dried visco-elastic polymer precursor whereby said dried visco-elastic polymer precursor becomes a patterned visco-elastic polymer precursor; and
curing said patterned visco-elastic polymer precursor such that said visco-elastic polymer precursor is polymerized resulting in a vibration damping component.

33. The method of claim 32 wherein said applying said liquid visco-elastic polymer precursor comprises:
screen printing said liquid visco-elastic polymer precursor.

34. The method of claim 32wherein said applying said liquid visco-elastic polymer precursor comprises:
applying said liquid visco-elastic polymer to a cavity defined in said substrate, said cavity open on at least one side for receiving said liquid visco-elastic polymer.

35. The method of claim 32wherein said applying said liquid visco-elastic polymer precursor comprises:
screen printing said liquid visco-elastic polymer precursor.

36. The method of claim 32 wherein said applying said liquid visco-elastic polymer precursor comprises:
squirting said liquid visco-elastic polymer precursor onto said substrate.

37. The method of claim 32 wherein said patterning said dried visco-elastic polymer precursor comprises:
utilizing photolithography to pattern said dried visco-elastic polymer precursor.

38. The method of claim 37 wherein said utilizing photolithography to pattern said dried visco-elastic polymer precursor comprises:
utilizing liquid photoresist to pattern said dried visco-elastic polymer precursor.

39. The method of claim 37 wherein said utilizing photolithography to pattern said dried visco-elastic polymer precursor comprises:
utilizing dry photoresist to pattern said dried visco-elastic polymer precursor.

40. The method of claim 32 wherein said patterning said dried visco-elastic polymer precursor comprises:
applying an organic solvent to said dried visco-elastic polymer precursor.

41. The method of claim 32 further comprising:
pressing a constraining layer onto said dried visco-elastic polymer precursor.

42. A method for damping vibration, said method comprising:
applying a liquid visco-elastic polymer precursor to a substrate;
curing said liquid visco-elastic polymer precursor whereby said liquid visco-elastic polymer precursor is polymerized; and
patterning said polymerized visco-elastic polymer precursor resulting in a micro-machined visco-elastic damping device.

43. The method of claim 42 wherein said applying said liquid visco-elastic polymer precursor comprises:
screen printing said liquid visco-elastic polymer precursor.

44. The method of claim 42 wherein said applying said liquid visco-elastic polymer precursor comprises:
applying said liquid visco-elastic polymer to a cavity defined in said substrate, said cavity open on at least one side for receiving said liquid visco-elastic polymer.

45. The method of claim 42 wherein said applying said liquid visco-elastic polymer precursor comprises:
screen printing said liquid visco-elastic polymer precursor.

46. The method of claim 42 wherein said applying said liquid visco-elastic polymer precursor comprises:
squirting said liquid visco-elastic polymer precursor onto said substrate.

47. The method of claim 42 wherein said patterning said polymerized visco-elastic polymer precursor comprises:
utilizing photolithography to pattern said dried visco-elastic polymer precursor.

48. The method of claim 47 wherein said utilizing photolithography to pattern said polymerized visco-elastic polymer precursor comprises:
utilizing liquid photoresist to pattern said dried visco-elastic polymer precursor.

49. The method of claim 47 wherein said utilizing photolithography to pattern said polymerized visco-elastic polymer precursor comprises:
utilizing dry photoresist to pattern said dried visco-elastic polymer precursor.

50. The method of claim 42 wherein said patterning said polymerized visco-elastic polymer precursor comprises:
applying oxygen plasma to said polymerized visco-elastic polymer precursor.
